(19) United States
(12) Patent Application Publication
(10) Pub. No.: US 2013/0182680 A1
(43) Pub. Date: Jul. 18, 2013

(54) METHOD FOR MACHINE TYPE COMMUNICATION USER EQUIPMENT TO CONNECT TO EVOLVED NODE-B AND APPARATUS EMPLOYING THE SAME

(71) Applicant: Electronics and Telecommunications Research Institute, Daejeon (KR)

(72) Inventors: Seung Nam CHOI, Daejeon (KR); Il Gyu KIM, Chungbuk (KR)

(73) Assignee: Electronics and Telecommunications Research Institute, Daejeon (KR)

(21) Appl. No.: 13/716,883

(22) Filed: Dec. 17, 2012

(30) Foreign Application Priority Data
Jan. 18, 2012 (KR) 10-2012-0005796
Jun. 8, 2012 (KR) 10-2012-0061429

(51) Int. Cl. H04W 36/14

(52) U.S. Cl. CPC H04W 36/14
USPC 370/331

(57) ABSTRACT

Provided are a method for machine type communication (MTC) user equipment (UE) to connect to an evolved Node-B (eNB) in a random access procedure, and an apparatus employing the method. The method for MTC UE to connect to an eNB includes receiving, at the MTC UE, system information or a handover command from the eNB, transmitting, at the MTC UE, a random access preamble to the eNB, receiving, at the MTC UE, a random access response message from the eNB, and transmitting, at the MTC UE, a connection request message or a handover confirm message including information about a dedicated bandwidth of the MTC UE to the eNB such that the MTC UE can be allocated the dedicated bandwidth. Using this method, an eNB is notified of a dedicated bandwidth of MTC UE, and thus can effectively utilize radio resources.

### CLAIM FOR PRIORITY

This application claims priority to Korean Patent Application No. 10-2012-0005796 filed on Jan. 18, 2012 and Korean Patent Application No. 10-2012-0061429 filed on Jun. 8, 2012 in the Korean Intellectual Property Office (KIPO), the entire contents of which are hereby incorporated by reference.

### BACKGROUND

1. Technical Field

Example embodiments of the present invention relate in general to wireless connection, and more particularly, to a method for machine type communication (MTC) user equipment (UE) to connect to an evolved Node-B (eNB) in a random access procedure and an apparatus employing the method.

2. Related Art

Machine-to-machine communication (M2M) (or MTC) is a form of data communication which involves one or more entities that do that necessarily require human interaction. M2M enables autonomous communication between objects as well as existing communication between persons and between a person and an object. Information shared on the basis of such autonomous communication between objects may be converted into a service form and then applied to our various daily lives, thereby enabling more convenient and safer living.

Currently, many international organizations for standardization are using terms of similar concepts in relation to M2M. For example, European telecommunications standards institute (ETSI) is working on standardization in which the term M2M is used as a keyword, and Third Generation Partnership Project (3GPP) is working on standardization using the term MTC.

In particular, until now, 3GPP has mainly discussed MTC standardization for upper layers related to a network and a system, but has recently started a full-scale discussion of MTC standardization for a physical layer as well. In a 3GPP Long Term Evolution (LTE)-Advanced standard, frequency bandwidths of 1.4 MHz, 3 MHz, 5 MHz, 10 MHz, 15 MHz and 20 MHz are supported for communication between UE and an eNB. An eNB utilizes one of these bandwidths (e.g., 20 MHz), but the UE does not know which bandwidth an eNB of each cell utilizes and thus should support all the bandwidths.

However, since UE supporting MTC (will be referred to as MTC UE below) is generally expected to be used for transmitting a small amount of information, it is inefficient to support all the bandwidths in terms of unit cost, power consumption, etc. of the MTC UE.

In addition, for an LTE service, communication service providers should accept many pieces of MTC UE as well as general communication UE in a cell using an eNB having a bandwidth of 10 MHz or 20 MHz. The many pieces of MTC UE disposed in the cell may cause problems such as scheduling competition for channel allocation, exhaustion of radio resources, and overload resulting from signal generation. Particularly, in a current 3GPP LTE-Advanced system, a standard for a random access procedure for general communication UE has been prepared, but no random access procedure has been clearly defined in consideration of an MTC service.

Furthermore, in a current 3GPP LTE-Advanced system, the same cell identifier (ID) should be used in the same cell, and thus interference may occur between general communication UE and MTC UE.

### SUMMARY

Accordingly, example embodiments of the present invention are provided to substantially obviate one or more problems due to limitations and disadvantages of the related art.

Example embodiments of the present invention provide a wireless connection method based on a random access procedure that can be applied to narrowband user equipment (UE) such as machine type communication (MTC) UE, and an apparatus employing the wireless connection method.

Example embodiments of the present invention also provide a wireless connection method that prevents interference between narrowband UE groups using a cell identifier (ID).

In some example embodiments, a wireless connection method includes: receiving, at MTC UE, system information or a handover command from an evolved Node-B (eNB); transmitting, at the MTC UE, a random access preamble to the eNB; receiving, at the MTC UE, a random access response message from the eNB; and transmitting, at the MTC UE, a connection request message or a handover confirm message including information about a dedicated bandwidth of the MTC UE to the eNB such that the MTC UE can be allocated the dedicated bandwidth.

Here, the system information may include system information block (SIB) information, and the SIB information may include random access information that allows distinguishment of the MTC UE from Long Term Evolution (LTE) UE.

Here, the random access preamble may be generated according to the random access information that allows distinguishment between the MTC UE and the LTE UE.

In other example embodiments, a wireless connection method includes: transmitting, at an eNB, system information or a handover command to MTC UE; receiving, at the eNB, a random access preamble from the MTC UE; transmitting, at the eNB, a random access response message to the MTC UE; and receiving, at the eNB, a connection request message or a handover confirm message including information about a dedicated bandwidth of the MTC UE from the MTC UE, and allocating a frequency band corresponding to the dedicated bandwidth of the MTC UE to the MTC UE.

Receiving, at the eNB, the random access preamble from the MTC UE may include distinguishing, at the eNB, between the MTC UE and LTE UE using the random access preamble.

The system information may include SIB information, and the eNB may transmit SIB information about the MTC UE by time-division multiplexing (TDM) at periods different from periods of transmitting SIB information about the LTE UE.

In the wireless connection method according to the other example embodiments, a virtual cell ID distinguished from a physical cell ID used by the eNB may be used for at least one MTC UE group.

Here, the virtual cell ID may be differently given to the respective at least one MTC UE group, or may be given to the respective group according to a frequency band used by the at least one MTC UE group.

In other example embodiments, MTC UE includes a receiver configured to receive system information or a handover command from an eNB; a transmitter configured to transmit a random access preamble to the eNB; and a controller configured to control the receiver and the transmitter. Here, the receiver receives a random access response message from the eNB, and the transmitter transmits a connection request message or a handover confirm message including information about a dedicated bandwidth of the MTC UE to the eNB such that the MTC UE can be allocated a frequency band corresponding to the dedicated bandwidth of the MTC UE.

Here, the receiver may support all frequency bands of the eNB, and the transmitter may only support the dedicated bandwidth of the MTC UE.

In other example embodiments, an eNB transmits system information or a handover command to MTC UE, receives a random access preamble from the MTC UE, transmits a random access response message to the MTC UE as a response to the random access preamble, receives a connection request message or a handover confirm message including information about a dedicated bandwidth of the MTC UE from the MTC UE, and allocates a frequency band corresponding to the dedicated bandwidth of the MTC UE to the MTC UE.

The system information may include SIB information, and the eNB may transmit SIB information about the MTC UE by TDM at periods different from periods of transmitting SIB information about LTE UE.

### BRIEF DESCRIPTION OF DRAWINGS

Example embodiments of the present invention will become more apparent by describing in detail example embodiments of the present invention with reference to the accompanying drawings, in which:

FIG. 1 is a procedure diagram showing a contention-based random access procedure in a Third Generation Partnership Project (3GPP) Long Term Evolution (LTE)-Advanced system;

FIG. 2 is a procedure diagram showing a non-contention-based random access procedure in a 3GPP LTE-Advanced system;

FIG. 3 is a procedure diagram showing a procedure for connecting machine type communication (MTC) user equipment (UE) to an evolved Node-B (eNB) according to example embodiments of the present invention;

FIG. 4 is a conceptual diagram illustrating a standard of a system information block (SIB) according to example embodiments of the present invention;

FIG. 5 is a timing diagram illustrating transmission of SIBs based on time-division multiplexing (TDM) according to example embodiments of the present invention;

FIG. 6 is a timing diagram illustrating transmission of random access messages based on TDM according to example embodiments of the present invention;

FIG. 7 is a conceptual diagram illustrating a center frequency of operating MTC UE according to example embodiments of the present invention;

FIG. 8 is a conceptual diagram illustrating interference occurring between MTC UE and LTE UE;

FIG. 9A is a conceptual diagram illustrating a case in which MTC UE groups utilize the same virtual cell identifier (ID) according to an example embodiment of the present invention;

FIG. 9B is an example diagram illustrating no interference occurring between MTC UE groups according to the example embodiment of FIG. 9A;

FIG. 10A is a conceptual diagram illustrating a case in which MTC UE groups utilize different virtual cell IDs dependent on respective frequencies according to an example embodiment of the present invention;

FIG. 10B is an example diagram illustrating no interference occurring between MTC UE groups according to the example embodiment of FIG. 10A;

FIG. 11 is an example diagram illustrating a case in which no interference occurs between MTC UE groups although the MTC UE groups use the same frequency band; and

FIG. 12 is a block diagram showing the constitution of MTC UE according to example embodiments of the present invention.

### DESCRIPTION OF EXAMPLE EMBODIMENTS OF THE PRESENT INVENTION

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “user equipment (UE)” used herein may be referred to as a mobile station (MS), user terminal (UT), wireless terminal, access terminal (AT), terminal, subscriber unit, subscriber station (SS), wireless device, wireless communication device, wireless transmit/receive unit (WTRU), mobile node, mobile, or other terms. Various example embodiments of UE may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or devices having a combination of such functions, but are not limited to these.

In addition, broadband UE (will be referred to as “Long Term Evolution (LTE) UE” below) used herein denotes UE that supports all the bandwidths of 1.4 MHz, 3 MHz, 5 MHz, 10 MHz, 15 MHz and 20 MHz conforming to LTE standard, and narrowband UE (will be referred to as “machine type communication (MTC) UE” below) denotes UE that supports an LTE-based narrow band (1.4 MHz, 3 MHz or 5 MHz).

The term “evolved Node-B (eNB)” used herein generally denotes a fixed or moving point that communicates with a device, and may be a common name for base station, Node-B, base transceiver system (BTS), access point, relay, femto-cell, and so on.

Hereinafter, example embodiments of the present invention will be described in detail with reference to the accompanying drawings.

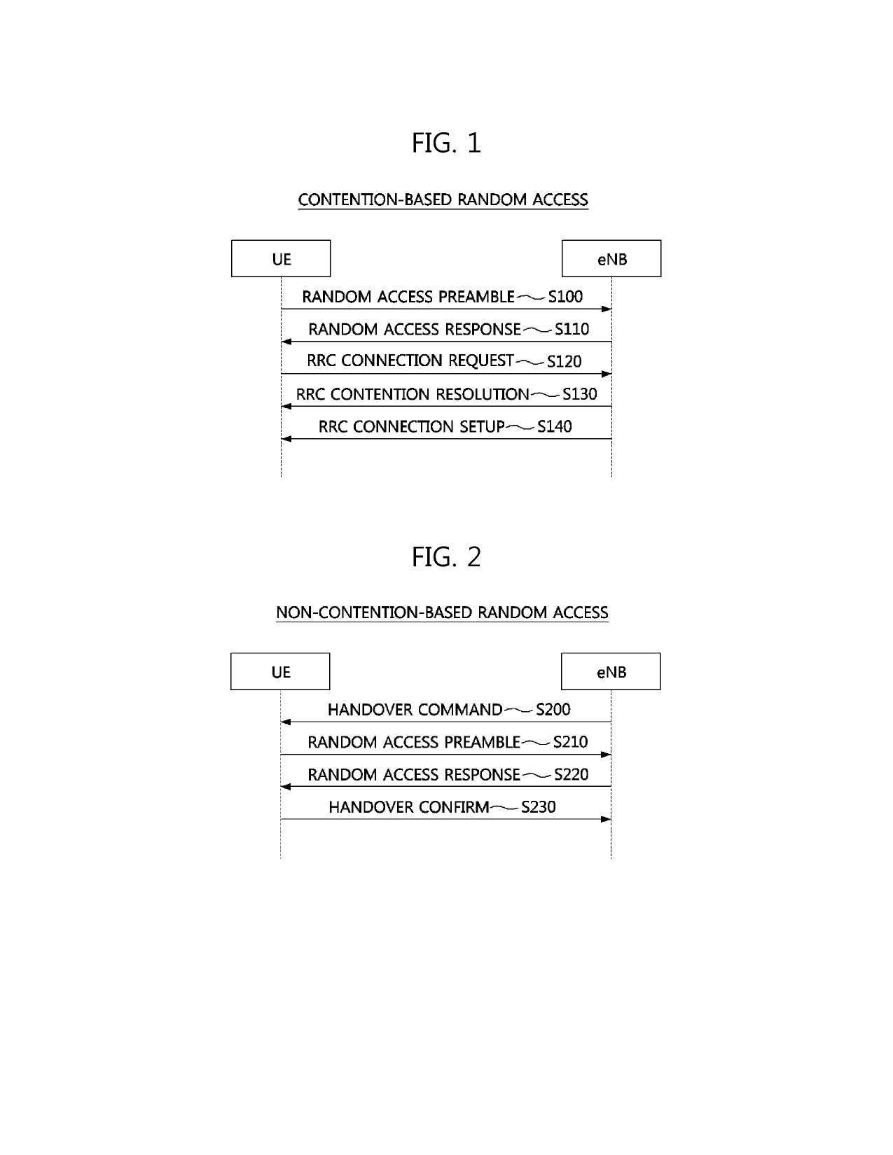

FIG. 1 is a procedure diagram showing a contention-based random access procedure in a Third Generation Partnership Project (3GPP) LTE-Advanced system.

Referring to FIG. 1, a random access procedure is a process for UE to connect to a network, and performed in the cases of initial connection, handover, scheduling request, uplink time synchronization, and so on. In other words, all UE perform random access for initial connection and data transmission. A random access procedure may be classified as a contention-based access procedure and a non-contention-based access procedure, and FIG. 1 illustrates the contention-based random access procedure. In the contention-based random access procedure in which one random access preamble is randomly selected and used from among a plurality of random access preambles used in common, UE may collide with other UE.

In the contention-based random access procedure shown in FIG. 1, UE transmits a random access preamble to an eNB, such that the eNB can estimate a transmission timing of the UE. The UE may randomly select a random access preamble using random-access-related system information that has been received from the eNB in advance, and transmit the selected random access preamble to the eNB (S100). In other words, transmission of the preamble is mainly intended to notify the eNB that there is a random access attempt, and enable the eNB to estimate delay between the UE and the eNB.

The eNB receives the random access preamble transmitted by the UE, and sends a random access response message to the UE in response to the random access preamble (S110). In response to the detected random access attempt, the eNB may transmit a random access response message including an index of a random access preamble sequence, a timing correction value, etc. on a downlink-shared channel (DL-SCH).

When the random access response message is successfully received in response to the random access preamble transmitted by the UE, the UE sends a radio resource control (RRC) connection request message to the eNB to establish an RRC connection using uplink-shared channel (UL-SCH) allocated by the eNB (S120).

The eNB receiving the RRC connection request message sends an RRC contention resolution message to the UE in response to the RRC connection request message (S130). In other words, when a plurality of pieces of UE simultaneously send RRC connection request messages, the eNB may transmit an RRC contention resolution message to pieces of UE that collide with each other.

Then, the eNB transmits an RRC connection setup message to the UE that has succeeded in establishing an RRC connection, thereby finishing the random access procedure (S140).

FIG. 2 is a procedure diagram showing a non-contention-based random access procedure in a 3GPP LTE-Advanced system.

Referring to FIG. 2, the non-contention-based random access procedure may be applied to handover. Before handover, an eNB may prevent collision of random access preambles by sending random access information to UE. In other words, the eNB may transmit a handover command including the random access information to the UE (S200).

The UE receiving the handover command transmits a random access preamble to the eNB that has transmitted the handover command (S210).

The eNB receiving the random access preamble transmits a random access response message to the UE in response to the random access preamble (S220). Here, S210 and S220 correspond to S100 and S110 of the contention-based random access procedure, respectively.

The UE receiving the random access response may finish handover by sending a handover confirm message to the eNB (S230).

In MTC service, such random access procedures may be caused by many pieces of MTC UE at the same time due to unique characteristics of the MTC service. Also, when MTC UE connects with an eNB in a 3GPP LTE system, the MTC UE should compete with general communication UE.

The present invention provides a method for MTC UE utilizing a dedicated narrow band to notify an eNB having a broad band of information about a bandwidth of the MTC UE in order to connect to the eNB.

The information about the bandwidth of the MTC UE corresponds to information about a system, and thus may be transmitted in a random access procedure every time the MTC UE attempts a wireless connection with an eNB.

In a wireless connection method of MTC UE according to example embodiments of the present invention, information about a bandwidth of the MTC UE may be added to a message in accordance with the random access procedure and transmitted.

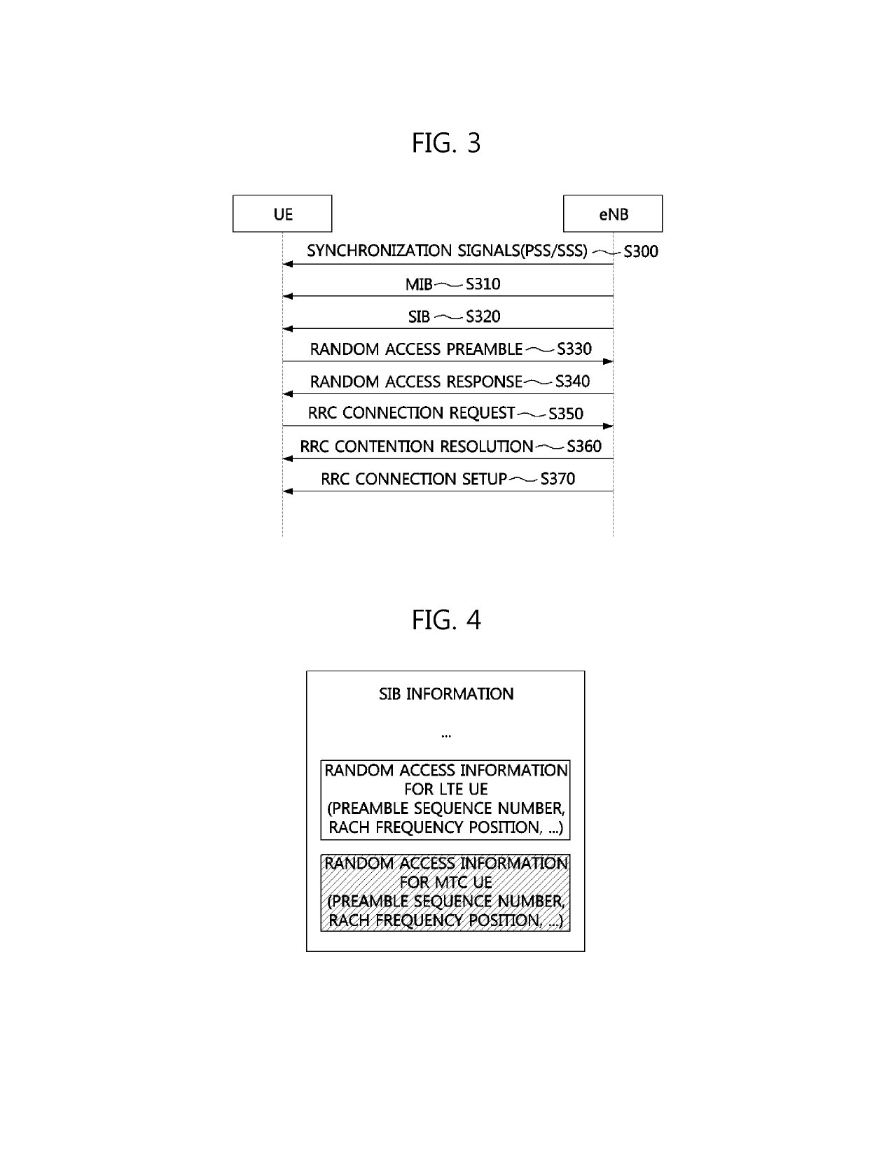

Referring to FIG. 1 and FIG. 3, in the contention-based random access procedure, MTC UE may include information about a bandwidth of the MTC UE in an RRC connection request message, and transmit the RRC connection request message. Referring to FIG. 2, in the non-contention-based random access procedure, MTC UE may include information about a bandwidth of the MTC UE in a handover confirm message, and transmit the handover confirm message.

In this way, MTC UE may notify an eNB of information about a bandwidth of the MTC UE in a random access procedure, and using the bandwidth information about the MTC UE, the eNB may prevent resources from being allocated to a frequency region that the MTC UE does not utilize. Also, the eNB may ensure scheduling flexibility, and effectively accept UE having various bandwidths in the same cell.

Thus, in the aspect of MTC UE, a wireless connection method according to example embodiments of the present invention includes: receiving, at the MTC UE, system information or a handover command from an eNB; transmitting, at the MTC UE, a random access preamble to the eNB; receiving, at the MTC UE, a random access response message from the eNB; and transmitting, at the MTC UE, a connection request message or a handover confirm message including information about a dedicated bandwidth of the MTC UE to the eNB such that the MTC UE can be allocated the dedicated bandwidth. Here, the system information may include system information block (SIB) information, and the connection request message may be an RRC connection request message.

In addition, in the aspect of an eNB, the wireless connection method according to example embodiments of the present invention includes: transmitting, at the eNB, system information or a handover command to MTC UE; receiving, at the eNB, a random access preamble from the MTC UE; transmitting, at the eNB, a random access response message to the MTC UE; and receiving, at the eNB, a connection request message or a handover confirm message including dedicated bandwidth information about the MTC UE from the MTC UE, and allocating a frequency band corresponding to the dedicated bandwidth of the MTC UE to the MTC UE.

This wireless connection method will be described in further detail with reference to FIG. 3.

FIG. 3 is a procedure diagram showing a procedure for connecting MTC UE to an eNB according to example embodiments of the present invention.

Referring to FIG. 3, in a process of connecting to an eNB, UE first performs synchronization through cell search. The eNB transmits synchronization signals (SSs) to the UE such that the UE can perform synchronization (S300). Since the eNB transmits the SSs to occupy six RBs of 1.4 MHz, MTC UE of 1.4 MHz can perform synchronization. Here, the SSs include a primary synchronization signal (PSS) and a secondary synchronization signal (SSS), and enable the UE to obtain a reception time point with respect to a specific cell in an initial cell search process.

After the UE finishes cell search, the eNB may transmit a master information block (MIB) to the UE through a physical broadcast channel (PBCH) using the resources of six RBs (S310). Since bandwidth information about the eNB is included in the MIB, the UE can continuously receive a signal from the eNB.

Also, the eNB transmits SIB information through a physical downlink shared channel (PDSCH) (S320). Since the SIB information is transmitted through the PDSCH in an entire band used by the eNB, MTC UE having a different bandwidth than the eNB cannot receive the SIB information. Thus, the MTC UE may not connect to the eNB. Here, S330 to S370 denoting a random access procedure are the same as the contention-based random access procedure illustrated in FIG. 1, and description thereof will be omitted.

For this reason, the present invention provides example embodiments that cause UE to effectively receive SIB information.

### Example Embodiment 1

In order for MTC UE that utilizes a narrower bandwidth (1.4 MHz, 3 MHz or 5 MHz) than LTE UE to connect with an eNB that supports a maximum bandwidth of 20 MHz, a receiver that supports all the bandwidths (1.4 MHz, 3 MHz, 5 MHz, 10 MHz, 15 MHz and 20 MHz) is applied to the MTC UE, like LTE UE.

The receiver of the MTC UE supports all the bandwidths, and a transmitter of the MTC UE only supports a dedicated narrow band. In other words, SIB information and a random access response message can be transmitted in a broad band (20 MHz), and thus the receiver of the MTC UE should be able to support all the bandwidths. Also, wherever a random access channel (RACH) frequency position is allocated, the MTC UE may change a center frequency of the MTC UE according to a RACH frequency allocated by the eNB, and transmit a random access preamble.

Thus, a receiver of MTC UE according to example embodiments of the present invention may support a frequency band of an eNB, and a transmitter of the MTC UE may only support a dedicated bandwidth of the MTC UE.

In this way, MTC UE according to example embodiment 1 operates like LTE UE until reception of a random access response message, and thereafter supports only a dedicated narrow band, thereby reducing power consumption.

However, in example embodiment 1, a receiver of MTC UE supports all the bandwidths, and thus the MTC UE may show lower efficiency than MTC UE whose transmitter and receiver both support a dedicated narrow band.

According to such example embodiment 1, an SIB standard for a current 3GPP LTE-Advanced system may not be modified.

### Example Embodiment 2

FIG. 4 is a conceptual diagram illustrating a standard of an SIB according to example embodiments of the present invention.

Referring to FIG. 4, SIB information may include pieces of random access information (a preamble sequence number, a RACH frequency position, and so on) to be used by UE.

In Example embodiment 2, SIB information may be modified for MTC service in a current 3GPP LTE-Advanced system.

As SIB information, pieces of random access information for LTE UE and MTC UE may be distinguished from each other, and pieces of UE may be notified of the corresponding pieces of random access information, respectively. For example, among the pieces of random access information for LTE UE and MTC UE, a parameter for distinguishing between the two types of UE may be a preamble sequence number or a RACH frequency position. In other words, to distinguish between LTE UE and MTC UE, used preamble sequence numbers may be made to differ from each other, or while preamble sequence numbers are identical, RACH frequency positions may be made to differ from each other. Also, RACH frequency positions as well as preamble sequence numbers of LTE UE and MTC UE may be made to differ from each other to distinguish between the types of UE.

Thus, SIB information may include random access information that allows distinguishment between MTC UE and LTE UE, and a random access preamble may be generated according to the random access information that allows distinguishment between MTC UE and LTE UE.

An eNB may receive the random access preamble and determine whether UE is LTE UE or MTC UE. In other words, the eNB may distinguish between MTC UE and LTE UE using the random access preamble. Also, the eNB may be notified of accurate information about a bandwidth of MTC UE by an RRC connection request message.

In example embodiment 2, a receiver of MTC UE may support all the bandwidths (1.4 MHz, 3 MHz, 5 MHz, 10 MHz, 15 MHz and 20 MHz). In other words, while a receiver of MTC UE supports all the bandwidths, a transmitter of the MTC UE only supports a dedicated narrow band.

In addition, wherever a RACH frequency position is allocated, MTC UE may change a center frequency of the MTC UE according to a RACH frequency allocated by an eNB, and transmit a random access preamble.

Furthermore, MTC UE in accordance with example embodiment 2 operates like LTE UE until reception of a random access response message, and thereafter supports only a dedicated narrow band, thereby reducing power consumption.

### Example Embodiment 3

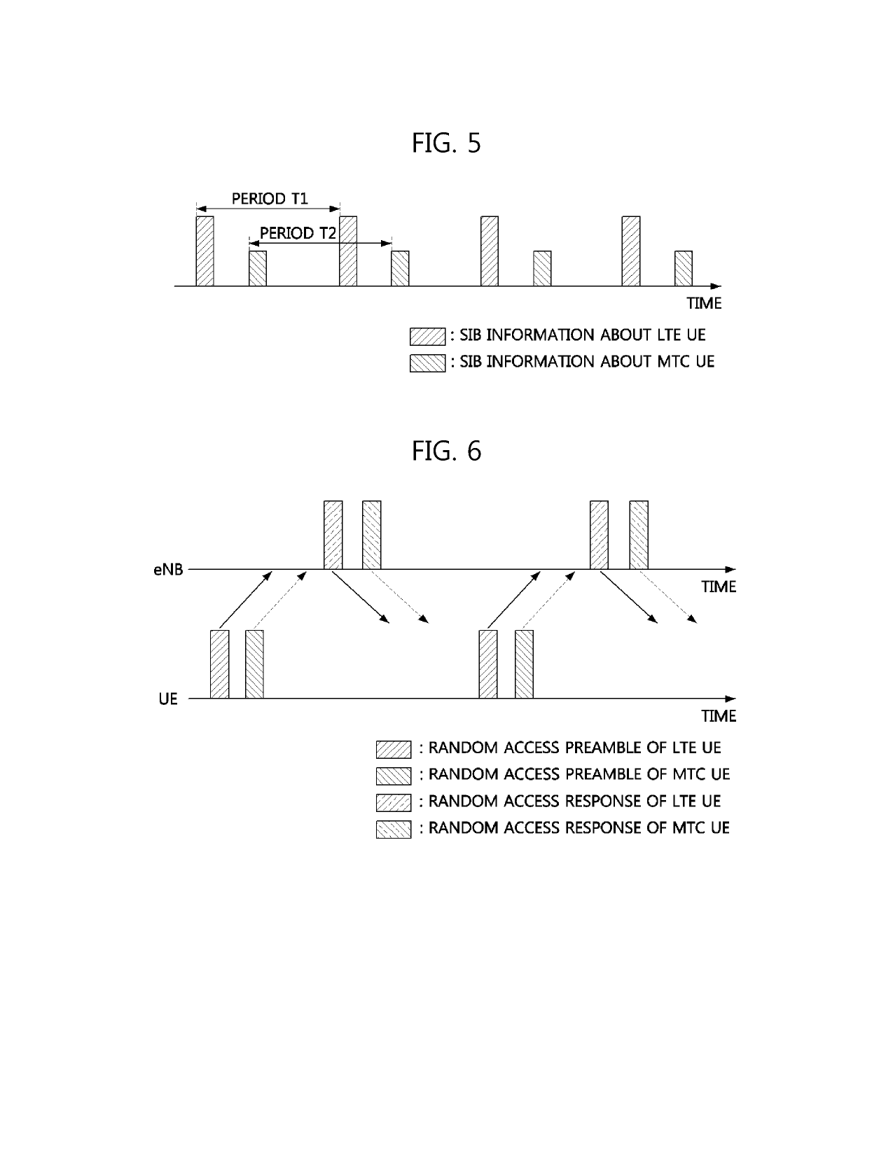

FIG. 5 is a timing diagram illustrating transmission of SIBs based on time-division multiplexing (TDM) according to example embodiments of the present invention, and FIG. 6 is a timing diagram illustrating transmission of random access messages based on TDM according to example embodiments of the present invention.

In an LTE-Advanced system, an eNB periodically transmits SIB information to UE.

Referring to FIG. 5, an eNB transmits SIB information about LTE UE at periods of T1, and SIB information about MTC UE at periods of T2 by TDM. In other words, the eNB may transmit the SIB information about the MTC UE by TDM at periods different from the periods of transmitting the SIB information about the LTE UE. Here, the SIB information about the MTC UE may be newly generated according to a narrow band (1.4 MHz), or SIB information about LTE UE used in the narrow band may be used as the SIB information about the MTC UE.

In this case, since the SIB information about the MTC UE is transmitted by TDM at different periods than the SIB information about the LTE UE, a receiver of the MTC UE may only support a dedicated narrow band. Also, since the SIB information about the LTE UE and the SIB information about the MTC UE may differ from each other, the eNB may receive a random access preamble to determine the type of UE.

Referring to FIG. 6, the UE may transmit random access preambles corresponding to the received SIB information to the eNB. In particular, random access messages of the LTE UE and the MTC UE may be transmitted and received to be temporally distinguished from each other. Here, the random access messages may include the random access preambles and random access response messages. In this way, the MTC UE may transmit and receive random access messages corresponding to the MTC UE distinguishably from random access messages corresponding to the LTE UE.

In example embodiment 3, since a transmitter and a receiver of MTC UE may only support a dedicated narrow band, it is possible to reduce hardware complexity, production cost per unit, and power consumption of the MTC UE.

The dedicated narrow band supported by the MTC UE may be 3 MHz or 5 MHz as well as 1.4 MHz.

According to such example embodiment 3, a standard for supporting MTC UE may be added to a standard of a current 3GPP LTE-Advanced system.

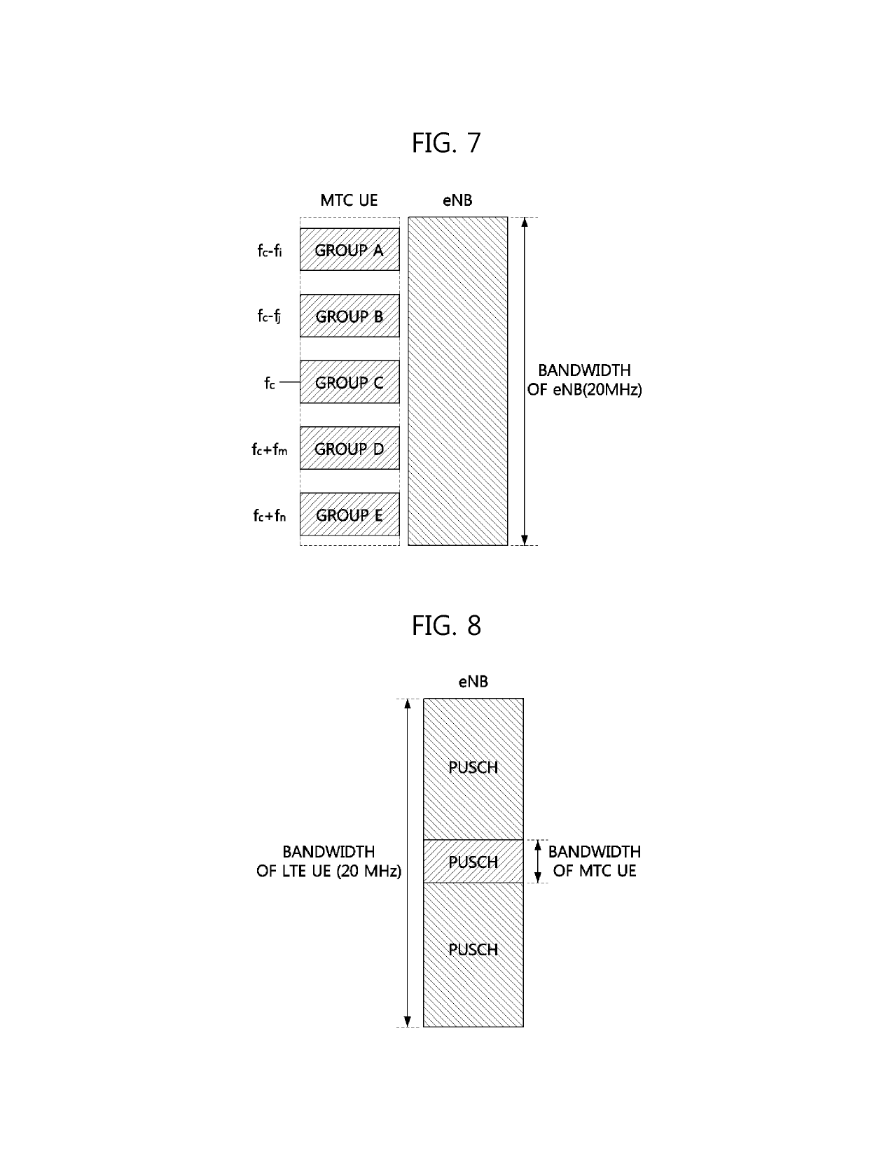

FIG. 7 is a conceptual diagram illustrating a center frequency of operating MTC UE according to example embodiments of the present invention.

Assuming that an eNB supports a bandwidth of 20 MHz, a center frequency at which MTC UE operates will be described with reference to FIG. 7. When a dedicated narrow band supported by the MTC UE is 1.4 MHz, a center frequency may be fixed at f_{c}. However, the MTC UE is connected with the eNB in a narrow band, and thus may operate in all the frequency bands of the eNB by changing the center frequency. For example, while MTC UE belonging to group C may have a center frequency of f_{c}, MTC UE belonging to group A may have a center frequency of f_{c}−fᵢ, and MTC UE belonging to group B may have a center frequency of f_{c}−fⱼ. Also, MTC UE belonging to group D may have a center frequency of f_{c}+fₘ, and MTC UE belonging to group E may have a center frequency of f_{c}+fₙ.

In other words, when MTC UE operates in all the frequency bands of an eNB by only changing a center frequency, the eNB may group and manage pieces of MTC UE in a cell according to specific frequency bands, thereby efficiently utilizing radio resources of the cell.

FIG. 8 is a conceptual diagram illustrating interference occurring between MTC UE and LTE UE.

Referring to FIG. 8, when MTC UE is used together with LTE UE in a cell of an eNB utilizing a bandwidth of 20 MHz, interference may occur between the MTC UE and the LTE UE. In particular, in the case of signal transmission through a physical uplink shared channel (PUSCH), the MTC UE and the LTE UE utilize the same frequency region, and interference may occur between the MTC UE and the LTE UE. In other words, the LTE UE supports all the bandwidths of the eNB, and thus mutual interference may occur between the LTE UE and the MTC UE supporting a narrow band.

To remove interference, orthogonality should be maintained between demodulation reference signals (DM-RSs). Here, the greater the number of pieces of MTC UE, the less resources there are for maintaining the orthogonality between DM-RSs.

For this reason, example embodiments of the present invention provide a method of avoiding interference between MTC UE and LTE UE using a cell identifier (ID). In other words, while a current 3GPP LTE-Advanced system utilizes the same cell ID in the same cell, a virtual cell ID distinguished from a physical cell ID used by an eNB can be used for at least one MTC UE group in a method for an eNB to connect with at least one MTC UE group according to example embodiments of the present invention.

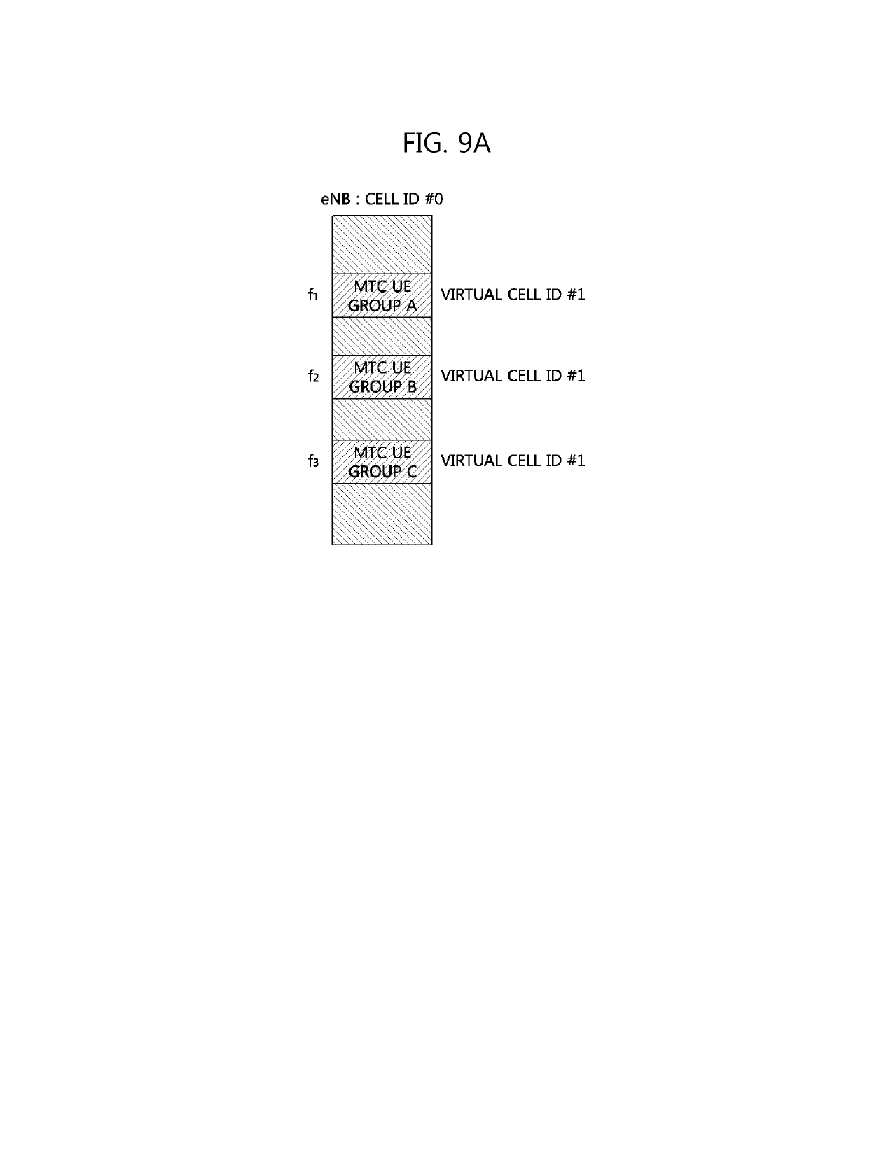

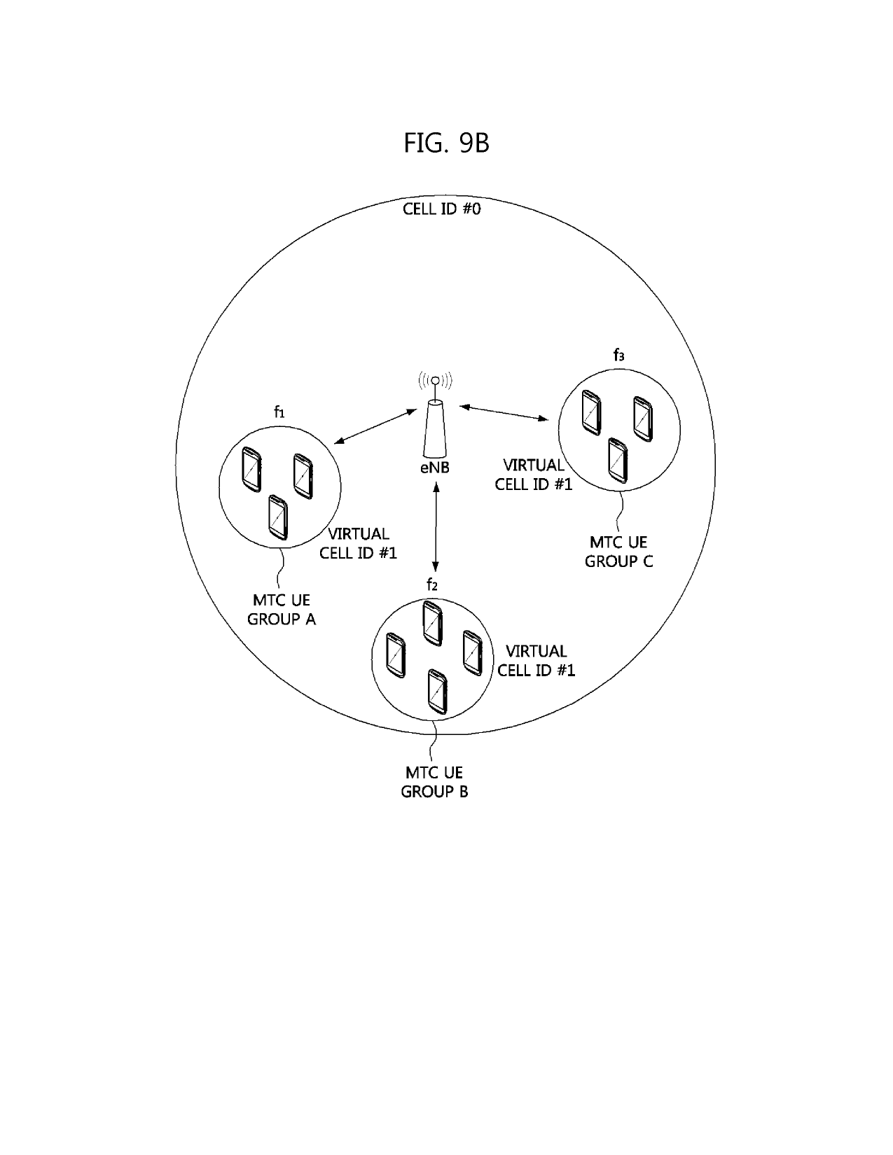

FIG. 9A is a conceptual diagram illustrating a case in which MTC UE groups utilize the same virtual cell ID according to an example embodiment of the present invention, and FIG. 9B is an example diagram illustrating no interference occurring between MTC UE groups according to the example embodiment of FIG. 9A.

Referring to FIG. 9A and FIG. 9B, MTC UE may utilize a virtual cell ID that is distinguished from an existing cell ID used by an eNB. For example, in the same cell, LTE UE may use cell ID#0, and MTC UE may use virtual cell ID#1.

Thus, all MTC UE groups that have different center frequency positions in the same cell may utilize virtual cell ID#1 that is the same virtual cell ID.

In other words, all the MTC UE groups consisting of at least one piece of MTC UE utilize virtual cell ID#1 that is the same virtual cell ID, but utilize different frequency bands, such that interference between MTC UE groups can be avoided. For example, MTC UE group A, MTC UE group B and MTC UE group C all utilize the same virtual cell ID#1, but center frequencies of the respective groups may be f₁, f₂ and f₃, that is, different from each other.

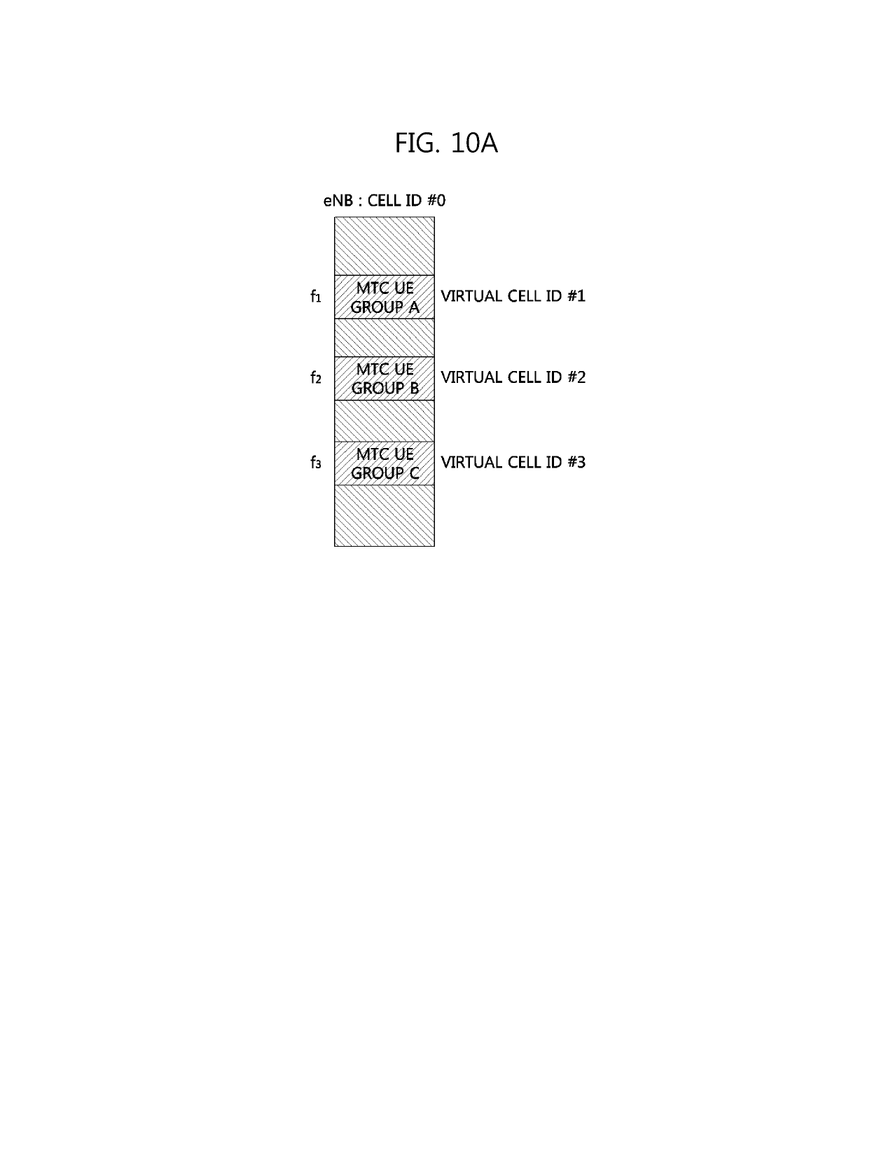

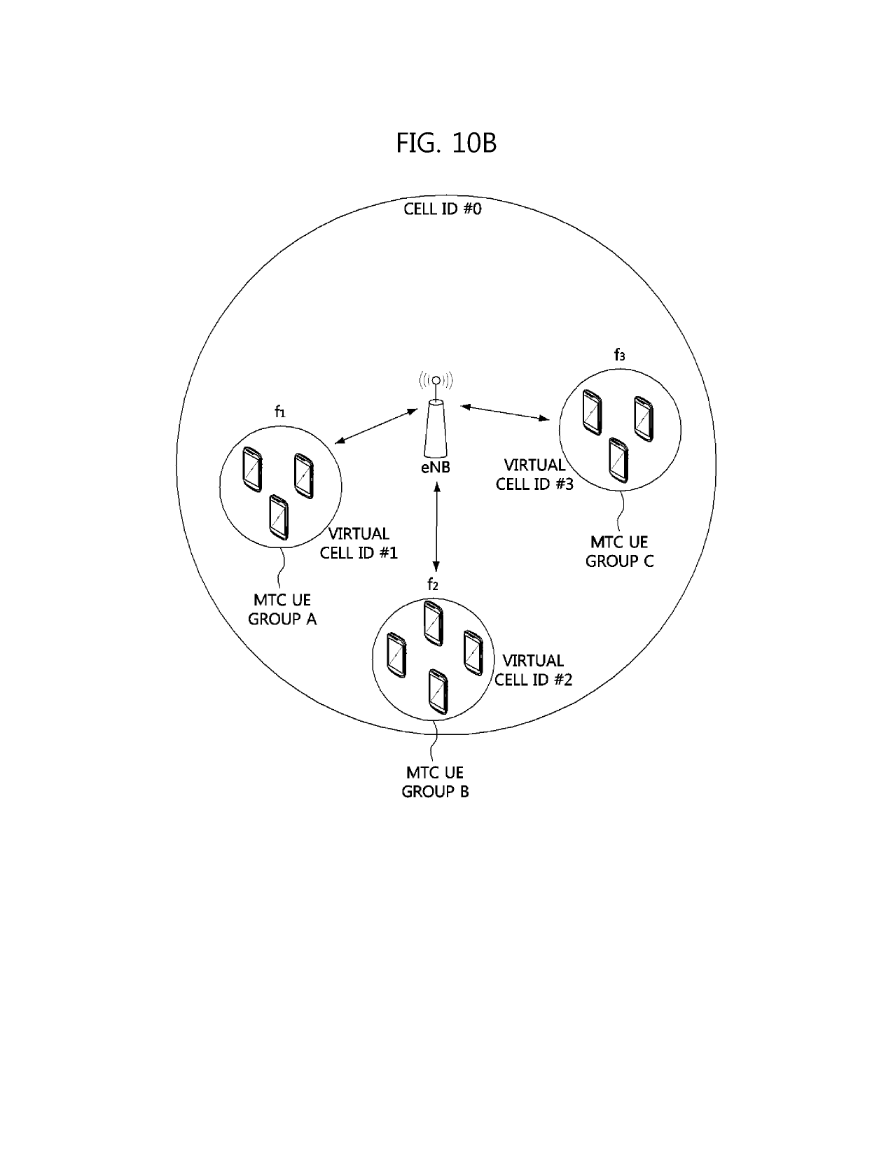

FIG. 10A is a conceptual diagram illustrating a case in which MTC UE groups utilize different virtual cell IDs dependent on respective frequencies according to an example embodiment of the present invention, and FIG. 10B is an example diagram illustrating no interference occurring between MTC UE groups according to the example embodiment of FIG. 10A.

Referring to FIG. 10A and FIG. 10B, different virtual cell IDs may be allocated according to frequency bands used by respective MTC UE groups. For example, MTC UE group A may have a center frequency of f₁ and a cell ID of virtual cell ID#1, MTC UE group B may have a center frequency of f₂ and a cell ID of virtual cell ID#2, and MTC UE group C may have a center frequency of f₃ and a cell ID of virtual cell ID#3.

In other words, a virtual cell ID may be differently given to respective at least one MTC UE group.

Also, the respective at least one MTC UE group may utilize different frequency bands, and the virtual cell ID may be given to the respective group according to a frequency band used by the at least one MTC UE group.

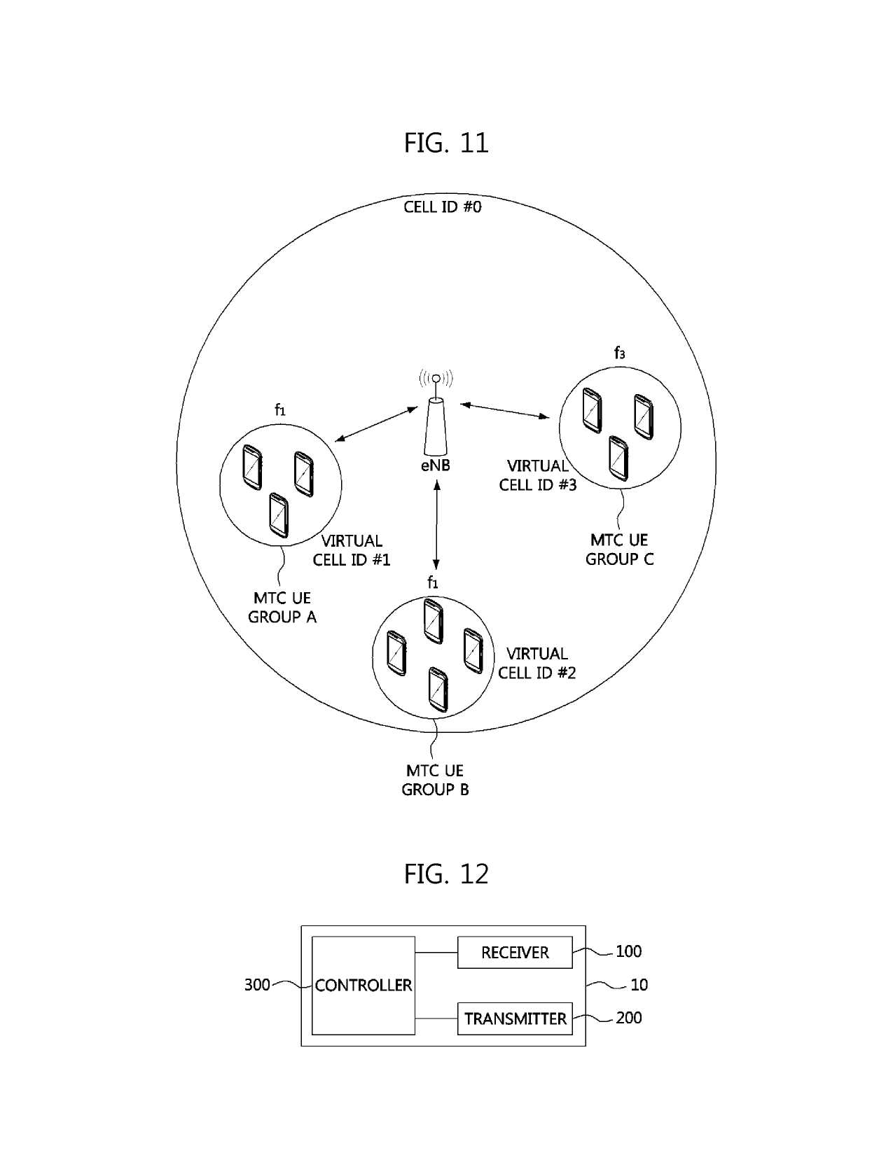

FIG. 11 is an example diagram illustrating a case in which no interference occurs between MTC UE groups although the MTC UE groups use the same frequency band.

Referring to FIG. 11, MTC UE groups may be managed such that frequency bands used by the respective groups are completely separated and do not overlap, or the frequency bands used by the groups partially overlap according to circumstances. For example, MTC UE group A and MTC UE group B have the same center frequency of f₁, but cell IDs of MTC UE group A and MTC UE group B may be virtual cell ID#1 and virtual cell ID#2, respectively, that is, different from each other. Also, MTC UE group C may have a center frequency of f₃, and a cell ID of virtual cell ID#3.

FIG. 12 is a block diagram showing the constitution of MTC UE according to example embodiments of the present invention.

Referring to FIG. 12, MTC UE 10 according to example embodiments of the present invention includes a receiver 100, a transmitter 200, and a controller 300.

The receiver 100 may receive system information or a handover command from an eNB. Also, the receiver 100 may receive a random access response message that is a response of the eNB to a random access preamble.

The transmitter 200 may transmit the random access preamble to the eNB, and transmit a connection request message or a handover confirm message including information about a dedicated bandwidth of the MTC UE 10 to the eNB. In this way, the MTC UE 10 may be allocated a frequency band corresponding to the dedicated bandwidth of the MTC UE 10 by the eNB.

In addition, the receiver 100 of the MTC UE 10 according to example embodiments of the present invention may be configured to support all frequency bands of the eNB, and the transmitter 200 may be configured to only support the dedicated bandwidth of the MTC UE 10.

The controller 300 may control the receiver 100 and the transmitter 200. In other words, the controller 300 may perform the contention-based random access procedure and the non-contention-based random access procedure by controlling the receiver 100 and the transmitter 200.

The eNB connected with the MTC UE 10 according to example embodiments of the present invention may transmit system information or a handover command to the MTC UE 10, receive a random access preamble from the MTC UE 10, transmit a random access response message to the MTC UE 10 as a response to the random access preamble, receive a connection request message or a handover confirm message including information about a dedicated bandwidth of the MTC UE 10 from the MTC UE 10, and allocate a frequency band corresponding to the dedicated bandwidth of the MTC UE 10 to the MTC UE 10.

In particular, the system information may include SIB information, and the eNB may transmit SIB information about the MTC UE 10 by TDM at periods different from periods of transmitting SIB information about LTE UE.

In addition, the eNB may connect with at least one MTC UE group, and utilize a virtual cell ID distinguished from a cell ID used for the LTE UE for the at least one MTC UE group. Here, the virtual cell ID may be differently given to the respective at least one MTC UE group, or may be given to the respective group according to a frequency band used by the at least one MTC UE group. Thus, different frequency bands or different cell IDs are allocated to MTC UE groups consisting of at least one piece of MTC UE, such that interference can be reduced between LTE UE and MTC UE or between pieces of MTC UE.

When the above-described wireless connection method according to example embodiments of the present invention is used, an eNB is notified of a dedicated bandwidth of MTC UE, and thus can more efficiently utilize radio resources.

Also, according to example embodiments of the present invention, it is possible to reduce hardware complexity, production cost per unit, and power consumption of MTC UE.

While the example embodiments of the present invention and their advantages have been described in detail, it should be understood that various changes, substitutions and alterations may be made herein without departing from the scope of the invention.

What is claimed is:

1. A method for machine type communication (MTC) user equipment (UE) to connect to an evolved Node-B (eNB), comprising:
receiving, at the MTC UE, system information or a handover command from the eNB;
transmitting, at the MTC UE, a random access preamble to the eNB;
receiving, at the MTC UE, a random access response message from the eNB; and
transmitting, at the MTC UE, a connection request message or a handover confirm message including information about a dedicated bandwidth of the MTC UE to the eNB such that the MTC UE is allocated the dedicated bandwidth.

2. The method of claim 1, wherein the system information includes system information block (SIB) information, and
the SIB information includes random access information for the MTC UE allowing distinguishment of the MTC UE from Long Term Evolution (LTE) UE.

3. The method of claim 2, wherein the random access preamble is generated on the basis of the random access information for the MTC UE.

4. The method of claim 2, wherein the random access information includes a preamble sequence number or a random access channel (RACH) frequency position as a parameter allowing distinguishment of the MTC UE from the LTE UE.

5. The method of claim 1, wherein the connection request message is a radio resource control (RRC) connection request message.

6. A method for an evolved Node-B (eNB) to connect with machine type communication (MTC) user equipment (UE), comprising:
transmitting, at the eNB, system information or a handover command to the MTC UE;
receiving, at the eNB, a random access preamble from the MTC UE;
transmitting, at the eNB, a random access response message to the MTC UE; and
receiving, at the eNB, a connection request message or a handover confirm message including information about a dedicated bandwidth of the MTC UE from the MTC UE, and allocating a frequency band corresponding to the dedicated bandwidth of the MTC UE to the MTC UE.

7. The method of claim 6, wherein receiving, at the eNB, the random access preamble from the MTC UE includes distinguishing, at the eNB, the MTC UE from Long Term Evolution (LTE) UE using the random access preamble.

8. The method of claim 6, wherein the system information includes system information block (SIB) information, and
the eNB transmits SIB information about the MTC UE by time-division multiplexing (TDM) at periods different from periods of transmitting SIB information about Long Term Evolution (LTE) UE.

9. The method of claim 6, wherein the eNB connects with at least one MTC UE group, and utilizes a virtual cell identifier (ID) distinguished from a cell ID used for Long Term Evolution (LTE) UE for the at least one MTC UE group.

10. The method of claim 9, wherein the virtual cell ID is differently given according to the at least one MTC UE group, or given to the respective group according to a frequency band used by the at least one MTC UE group.

11. The method of claim 9, wherein the at least one MTC UE group utilizes different frequency bands according to the respective group.

12. Machine type communication (MTC) user equipment (UE) which connects with an evolved Node-B (eNB), comprising:
a receiver configured to receive system information or a handover command from the eNB;
a transmitter configured to transmit a random access preamble to the eNB; and
a controller configured to control the receiver and the transmitter,
wherein the receiver receives a random access response message from the eNB, and
the transmitter transmits a connection request message or a handover confirm message including information about a dedicated bandwidth of the MTC UE to the eNB such that the MTC UE is allocated a frequency band corresponding to the dedicated bandwidth of the MTC UE.

13. The MTC UE of claim 12, wherein the receiver supports all frequency bands of the eNB, and
the transmitter only supports the dedicated bandwidth of the MTC UE.

14. The MTC UE of claim 12, wherein the system information includes system information block (SIB) information, and
the SIB information includes random access information for the MTC UE allowing distinguishment of the MTC UE from Long Term Evolution (LTE) UE.

15. The MTC UE of claim 14, wherein the random access information includes a preamble sequence number or a random access channel (RACH) frequency position as a parameter allowing distinguishment of the MTC UE from the LTE UE.

16. An evolved Node-B (eNB) which connects with machine type communication (MTC) user equipment (UE), the eNB transmitting system information or a handover command to the MTC UE, receiving a random access preamble from the MTC UE, transmitting a random access response message to the MTC UE as a response to the random access preamble, receiving a connection request message or a handover confirm message including information about a dedicated bandwidth of the MTC UE from the MTC UE, and allocating a frequency band corresponding to the dedicated bandwidth of the MTC UE to the MTC UE.

17. The eNB of claim 16, wherein the system information includes system information block (SIB) information, and
the eNB transmits SIB information about the MTC UE by time-division multiplexing (TDM) at periods different from periods of transmitting SIB information about Long Term Evolution (LTE) UE.

18. The eNB of claim 16, wherein the eNB connects with at least one MTC UE group, and utilizes a virtual cell identifier (ID) distinguished from a cell ID used for Long Term Evolution (LTE) UE for the at least one MTC UE group.
